(19) United States
(12) Patent Application Publication
(10) Pub. No.: US 2015/0249467 A1
(43) Pub. Date: Sep. 3, 2015

(54) STORAGE DEVICE, CONTROLLER, AND DATA WRITING METHOD

(71) Applicant: Kabushiki Kaisha Toshiba, Tokyo (JP)

(72) Inventors: Hironori NAKANISHI, Yokohama-shi (JP); Kana FURUHASHI, Kawasaki-shi (JP)

(73) Assignee: Kabushiki Kaisha Toshiba, Tokyo (JP)

(21) Appl. No.: 14/282,580

(22) Filed: May 20, 2014

Related U.S. Application Data
(60) Provisional application No. 61/947,049, filed on Mar. 3, 2014.

(51) Int. Cl. H03M 13/09; G06F 21/60; G06F 11/10

(52) U.S. Cl. CPC H03M 13/095; G06F 11/10; G06F 21/602

(57) ABSTRACT

According to one embodiment, a storage device includes a buffer configured to store encrypted data; an error detection code generator configured to generate an error detection code of the encrypted data; a key information generator configured to generate key information of an encryption key; a protection code generator configured to generate a protection code, which is an error detection code of the key information; a key information attaching unit configured to attach the key information and the protection code to the error detection code, and add the same to the encrypted data as redundant data; and a media configured to store the encrypted data.

### CROSS-REFERENCE TO RELATED APPLICATIONS

This application is based upon and claims the benefit of priority from U.S. Provisional Application No. 61/947049, filed on Mar. 3, 2014; the entire contents of which are incorporated herein by reference.

### FIELD

Embodiments described herein relate generally to a storage device, a controller, and a data writing method.

### BACKGROUND

There exists a storage device (e.g., hard disk drive) that can prevent stealing and leakage of stored data by storing the data after performing encryption using methods such as AES (Advanced Encryption Standard), and the like. There also exists a storage device in which an encryption key used in encryption and decryption of data can be appropriately updated. The security can be further enhanced by updating the encryption key. For example, by updating the encryption key when discarding the storage device that is no longer necessary, the information leak from the discarded storage device can be prevented.

The storage device having a configuration in which the encryption key can be updated also includes a storage device that adds information (hereinafter referred to as key information) of the encryption key, which is used in encrypting the data, to the data (data in the encrypted state), and stores the same. The key information is used to determine whether the encryption key used in the decryption of when reading out the data matches the encryption key used to encrypt the data. If the encryption key to decrypt the data does not match the encrypted data, the decryption is not correctly carried out, and the incoherent data is output from the storage device. In this case, problems may arise as determination cannot be made on whether or not the decryption is correctly carried out on the host side using the output data. For example, the operation of the host may become unstable, such as the host that received the data that is not correctly decrypted may malfunction, and the like. Assuming such case, the storage device executes the determination on whether or not the encryption key to be used in the decryption process is correct using the key information. The key information is, for example, information indicating the generation of the encryption key in which the value is incremented as the encryption key is updated.

A method of sharing a storage area by performing XOR of the key information with the data protection parity of the user data in order to avoid data other than the user data such as the key information from using a storage area for the user data of the storage device is well known. However, when adding (XOR) the key information to the data and storing the same, it is difficult to detect an error (the errors caused by a malfunction of the logic) of the key information added to the data when reading out the data. Thus, an error (malfunction) arises in the match and unmatch determination of the encryption key to be used in the decryption, and the operation may become unstable, for example, the data may not be read out, although the encryption key which is used to encrypt the data is used.

### BRIEF DESCRIPTION OF THE DRAWINGS

FIG. 1 is a view illustrating a configuration example of a storage device according to a present embodiment;

FIG. 2 is a view illustrating a configuration example of an encryption processor arranged in the storage device of FIG. 1;

FIG. 3 is a view illustrating a configuration example of a write processor and a readout processor arranged in the storage device of FIG. 1;

FIG. 4 is a view illustrating a method for generating redundant data according to the present embodiment;

FIG. 5 is a view illustrating an operation of the write processor arranged in the storage device of FIG. 1;

FIG. 6 is a view illustrating exclusive OR of an error detection code and the redundant data according to the present embodiment; and

FIG. 7 is a view illustrating an operation of the readout processor arranged in the storage device of FIG. 1.

### DETAILED DESCRIPTION

In general, according to one embodiment, a storage device including a buffer configured to store encrypted data; an error detection code generator configured to generate an error detection code of the encrypted data; a key information generator configured to generate key information which is information of an encryption key used in the encryption of the encrypted data; a protection code generator configured to generate a protection code which is an error detection code of the key information; a key information attaching unit configured to attach the key information and the protection code to the error detection code, and add to the encrypted data as redundant data; and a media configured to store the encrypted data added with the redundant data.

Exemplary embodiments of a storage device, a controller, and a data writing method will be explained below in detail with reference to the accompanying drawings. The present invention is not limited to the following embodiments.

### Embodiment

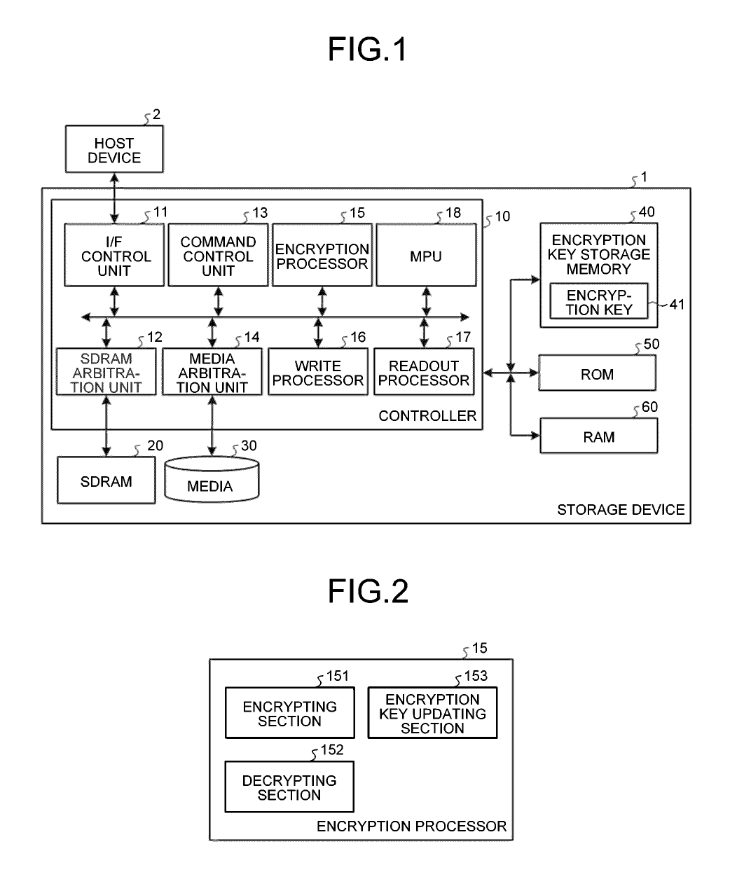

FIG. 1 is a view illustrating a configuration example of a storage device 1 according to the present embodiment. The storage device 1 includes a controller 10; an SDRAM 20 serving as a buffer that temporarily holds data, and the like to exchange with an external host device 2; a media 30 that stores data; an encryption key storage memory 40; a ROM (Read Only Memory) 50; and a RAM (Random Access Memory) 60. The controller 10 includes an I/F (interface) control unit 11, an SDRAM arbitration unit 12, a command control unit 13, a media arbitration unit 14, an encryption processor 15, a write processor 16, a readout processor 17, and an MPU (Micro Processing Unit) 18, and controls each unit of the storage device 1. In FIG. 1, one host device 2 is connected to the storage device 1, but a plurality of host devices 2 may be connected. For example, a configuration in which the storage device 1 is connected to a communication network, and a plurality of host devices is connected through the communication network may be adopted.

In the controller 10, the I/F control unit 11 exchanges various types of commands and data with the host device 2. The SDRAM arbitration unit 12 arbitrates an access operation to the SDRAM 20 by each unit in the controller 10, and executes write, readout, erase, and the like of the data with respect to the SDRAM 20. The command control unit 13 transmits and receives various types of commands with the host device 2, and also executes processes following the received command. For example, if a command instructing the write of the data is received, an instruction is issued to each unit in the controller 10 to execute the process for writing the data received with the command to the media 30. The media arbitration unit 14 arbitrates an access operation to the media 30 by each unit in the controller 10, and executes write, readout, erase, and the like of the data with respect to the media 30. The encryption processor 15 encrypts the data received from the host device 2 and stores the same in the SDRAM 20. If the data to be output to the host device 2 is stored in the SDRAM 20, such data is retrieved and decrypted. The write processor 16 adds redundant data with respect to the data (hereinafter referred to as actual data) held by the SDRAM 20, and writes the same in the media 30. The redundant data includes an error detection code of the actual data held by the SDRAM 20, and the like. The details on the redundant data will be described later. The readout processor 17 reads out the data (actual data added with the redundant data) written in the media 30, performs an error check of the actual data, and the like, and stores the actual data in the SDRAM 20 if problem is not found. The MPU 18 develops a program stored in the ROM 50 on the RAM 60 and executes the program to control each unit in the controller 10.

In the configuration example illustrated in FIG. 1, the encryption processor 15 exists inside the controller 10, but the encryption processor 15 may exist outside the controller 10.

The encryption key storage memory 40 holds an encryption key 41 to be used in the encryption process and the decryption process of the data by the encryption processor 15. The encryption key 41 is updated, for example, when receiving a change instruction from the host device 2. The method for updating the encryption key (method for generating a new encryption key) is arbitrary. In the present embodiment, the encryption key storage memory 40 and the media 30 are separate configurations, but an area for storing the encryption key 41 may be arranged in the media 30. The encryption key storage memory 40 may be arranged at one part of the RAM 60. The ROM 50 holds programs and various types of information for operating the storage device 1. The RAM 60 is used as a development memory and an operation memory for the program and the information stored in the ROM 50.

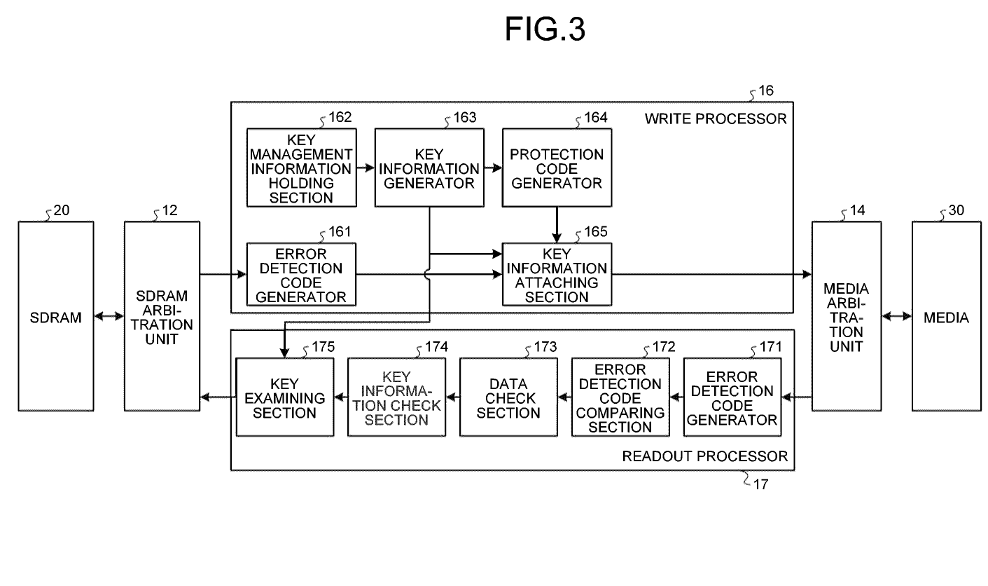

Now, the encryption processor 15, the write processor 16, and the readout processor 17 arranged in the controller 10 will be described. FIG. 2 is a view illustrating a configuration example of the encryption processor 15, and FIG. 3 is a view illustrating a configuration example of the write processor 16 and the readout processor 17. For the sake of convenience of the explanation, the configuring elements associated with the operations of the write processor 16 and the readout processor 17 are also described in FIG. 3.

[Encryption Processor 15]

As illustrated in FIG. 2, the encryption processor 15 includes an encrypting section 151, a decrypting section 152, and an encryption key updating section 153.

The encrypting section 151 receives the data written in the media 30 and encrypts the data. In the encryption process, the encryption key 41 held by the encryption key storage memory 40 is used. After the encryption is completed, the data in the encrypted state is stored in the SDRAM 20 as the actual data to be written to the media 30.

The decrypting section 152 retrieves the actual data read out from the media 30 and stored in the SDRAM 20 by the readout processor 17, and decrypts such data using the encryption key 41.

For example, the data subjected to encryption by the encrypting section 151 is the data (write data) received from the host device 2, and the actual data subjected to decryption by the decrypting section 152 is the data (readout data) to output to the host device 2.

When receiving the change instruction from the host device 2, for example, the encryption key updating section 153 updates the encryption key 41 held in the encryption key storage memory 40. The method for updating the encryption key (method for generating a new encryption key) is arbitrary.

[Write Processor 16]

As illustrated in FIG. 3, the write processor 16 includes an error detection code generator 161, a key management information holding section 162, a key information generator 163, a protection code generator 164, and a key information attaching section 165.

The error detection code generator 161 retrieves the actual data stored in the SDRAM 20 through the SDRAM arbitration unit 12, and generates an error detection code of the retrieved actual data. For example, CRC (Cyclic Redundancy Check) is generated as the error detection code. The actual data retrieved from the SDRAM 20 by the error detection code generator 161 is encrypted by the encrypting section 151 illustrated in FIG. 2. The generated error detection code is provided to the key information attaching section 165 along with the actual data.

The key management information holding section 162 holds the management information of the encryption key used in the encryption process by the encrypting section 151. When the encryption key 41 illustrated in FIG. 2 is updated, the management information held by the key management information holding section 162 is updated therewith. For example, when the encryption key 41 is updated, the encryption processor 15 notifies this to the write processor 16, and the write processor 16 updates the management information held by the key management information holding section 162. The management information is, for example, information indicating the generation of the encryption key (hereinafter referred to as key generation information). For example, the key generation information is information in which the value is incremented each time the encryption key 41 is updated.

The key information generator 163 reads out and processes the management information held by the key management information holding section 162, and generates the key information with less amount of information (number of bits) than the management information. For example, if the management information is the key generation information having an eight bit length, the generation of the encryption key can be expressed with a number of bits less than the eight bits in a state the aggregate number of updates of the encryption key is few. Thus, the key information generator 163 extracts low one bit or a few bits actually representing the generation of the key among the management information, and outputs as the key information. If the management information held by the key management information holding section 162 does not need to be processed, that is, if the key information with fewer number of bits than the management information cannot be generated, the key information generator 163 outputs the management information to the key information attaching section 165 as the key information.

The protection code generator 164 generates a protection code, which is the error detection code of the key information generated by the key information generator 163. For example, the CRC is generated as the protection code.

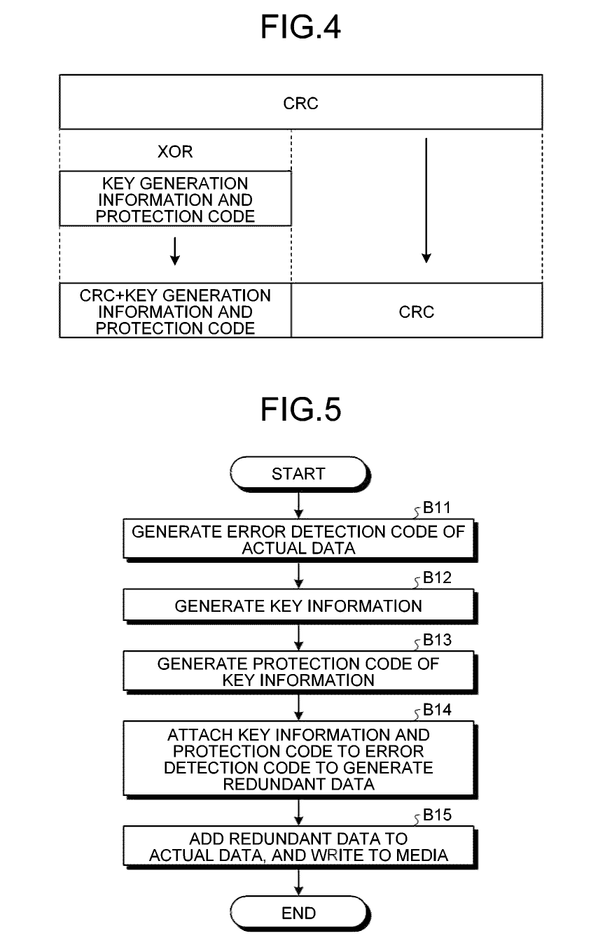

The key information attaching section 165 attaches the key information generated by the key information generator 163 and the protection code generated by the protection code generator 164 to the error detection code received from the error detection code generator 161 to generate redundant data. In this case, the redundant data having the same number of bits as the error detection code is generated. In other words, when attaching the key information and the protection code (hereinafter, the key information and the protection code are collectively referred to as key information with protection code) to the error detection code, an exclusive OR (XOR) is used (see FIG. 4). FIG. 4 illustrates a method for generating the redundant data of when using the CRC as the error detection code and using the key generation information as the key information. In other words, the key information attaching section 165 calculates the exclusive OR of the error detection code (CRC) and the key information with protection code (key generation information and protection code) to generate the redundant data, which is the error detection code attached with the key information with protection code. Since the lengths of the error detection code and the key information with protection code are different, a predetermined number of 0 is added to the key information with protection code so as to become the same length as the error detection code before calculating the exclusive OR. The generated redundant data is added to the actual data, and written to the media 30 through the media arbitration unit 14.

FIG. 5 is a flowchart illustrating one example of an operation of the write processor 16, specifically, the operation of adding the redundant data to the actual data stored in the SDRAM 20 and writing to the media 30. As illustrated in FIG. 5, the write processor 16 retrieves the actual data from the SDRAM 20, and generates the error detection code for detecting the error of the actual data (block B11). The information (key information) of the encryption key used in the encryption of the actual data is then generated (block B12), and the protection code for detecting the error of the key information is generated (block B13). The key information and the protection code are attached to the error detection code using the exclusive OR to generate the redundant data (block B14), and the redundant data is added to the actual data and written to the media 30 (block B15). The write processor 16 uses the exclusive OR when attaching the key information and the protection code to the error detection code, and thus the redundant data to be written to the media 30 can be prevented from increasing. Furthermore, the error detection of the key information can be carried out in the data readout operation (operation of the readout processor 17) to be described later since the redundant data contains the protection code of the key information,

[Readout Processor 17]

As illustrated in FIG. 3, the readout processor 17 includes an error detection code generator 171, an error detection code comparing section 172, a data check section 173, a key information check section 174, and a key examining section 175.

The error detection code generator 171 reads out the data (actual data added with the redundant data) specified from the host device 2 from the media 30, and generates the error detection code of the readout actual data. The error detection code is generated through a method same as the error detection code generator 161 of the write processor 16. After the generation of the error detection code is finished, the error detection code generator 171 outputs the error detection code to the error detection code comparing section 172 along with the actual data and the redundant data read out from the media 30.

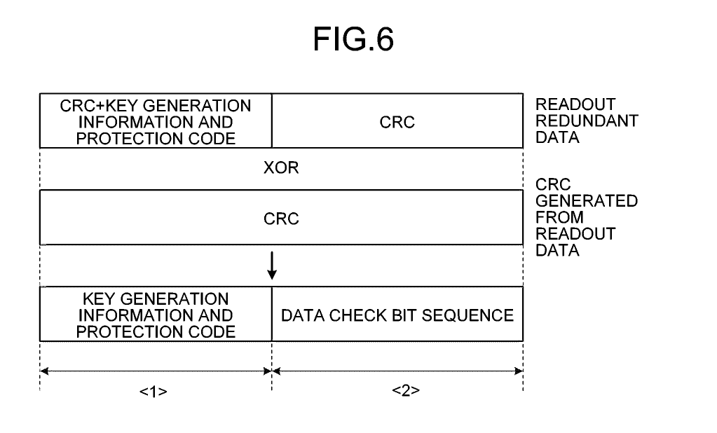

The error detection code comparing section 172 compares the redundant data (error detection code attached with the key information and the protection code) read out from the media 30 and the error detection code generated by the error detection code generator 171. Specifically, the exclusive OR of the redundant data and the error detection code is calculated (see FIG. 6). FIG. 6 is a view illustrating the exclusive OR of the error detection code generated by the error detection code generator 171 and the redundant data. In FIG. 6, the error detection code is assumed as the CRC, and the key information is assumed as the key generation information. As illustrated in FIG. 6, the redundant data is that in which the key information (key generation information in FIG. 6) and the protection code (key information with protection code) are attached to the error detection code (CRC in FIG. 6). Assuming an area where the key information with protection code is attached as a first area (area corresponding to <1> of FIG. 6), and the remaining area as a second area (area corresponding to <2> of FIG. 6) in the redundant data, the exclusive OR of a bit sequence of the first area and the error detection code (CRC) becomes the key information with protection code (key generation information, which is the key information, and the protection code) extracted from the redundant data. The exclusive OR of a bit sequence of the second area and the error detection code becomes the check result of whether or not an error is contained in the actual data read out from the media 30. For the sake of convenience of explanation, the exclusive OR of the second area is referred to as a data check bit sequence in the following description. The error detection code comparing section 172 outputs the comparison result (result of exclusive OR operation) and the actual data to the data check section 173.

The data check section 173 checks the error (bit error) of the actual data based on the comparison result in the error detection code comparing section 172. In other words, the data check section 173 determines that the error does not exist in the actual data if the data check bit sequence is zero (all bits are zero). If the error is not detected in the error check, the data check section 173 outputs the actual data and the exclusive OR of the first area (<1> of FIG. 6), described above, to the key information check section 174. As already described above, the exclusive OR of the first area is the key information with protection code extracted from the redundant data.

The data check section 173 acquires in advance the examination effective bit information from the host device 2 or the key information generator 163 of the write processor 16. The examination effective bit information is the information indicating which portion of the comparison result of the error detection code comparing section 172 corresponds to the second area (data check bit sequence). The host device 2 or the key information generator 163 notifies the examination effective bit information to the data check section 173 when detecting the update of the encryption key 41 (see FIG. 2).

The key information check section 174 checks the error (bit error) of the key information received from the data check section 173. If the error is not detected in the error check, the key information check section 174 outputs the actual data and the key information to the key examining section 175.

When receiving the actual data and the key information from the key information check section 174, the key examining section 175 confirms the key information, and determines whether or not the encryption key used in the encryption of the received actual data and the encryption key 41 (current encryption key) set in the encryption processor 15 match. If the encryption keys match, the key examining section 175 stores the actual data in the SDRAM 20. In other words, when receiving the actual data and the key information from the key information check section 174, the key examining section 175 acquires the key information of the current encryption key from the key information generator 163 of the write processor 16, and stores the actual data in the SDRAM 20 if the two received key information match. The key information of the current encryption key may be acquired in advance. For example, each time the actual data is written to the media 30, the key information generator 163 outputs the generated key information to the key information attaching section 165 and the key examining section 175, and the key examining section 175 holds the most recent key information received from the key information generator 163.

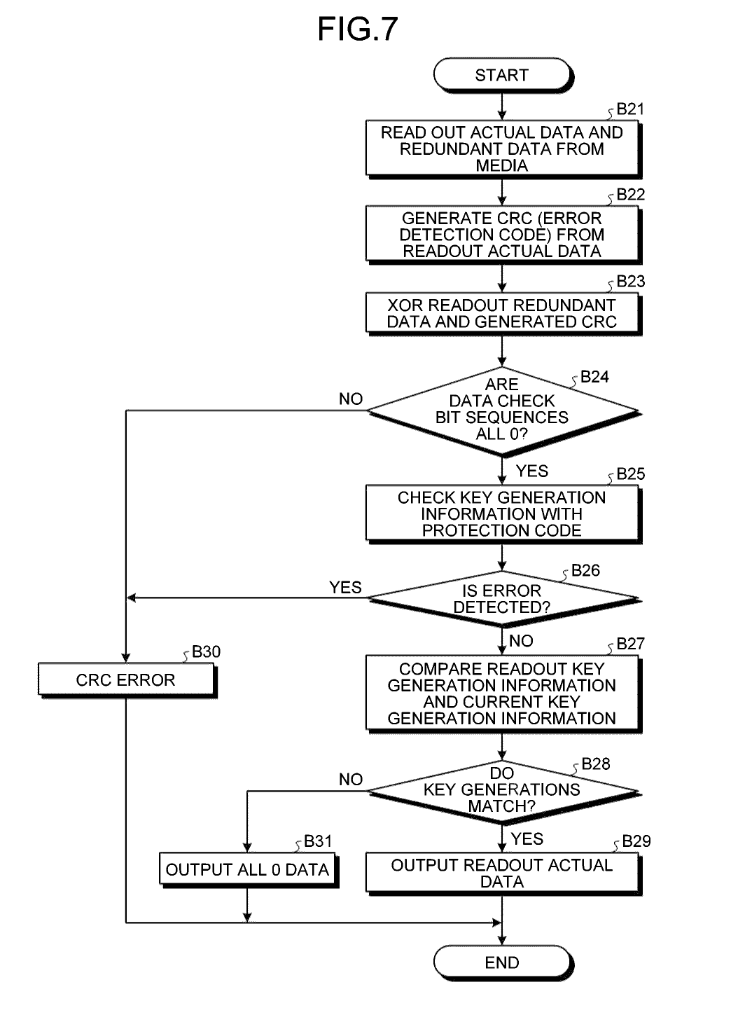

FIG. 7 is a flowchart illustrating one example of the operation of the readout processor 17, specifically, the operation of reading out the data instructed from the host device 2 from the media 30, performing the error check of the data, and the like and storing the same to the SDRAM 20. FIG. 7 illustrates an example in which the error detection code is the CRC and the key information is the key generation information. As illustrated in FIG. 7, in the readout processor 17, the error detection code generator 171 first reads out the actual data and the redundant data from the media 30 (block B21), and generates the CRC from the readout actual data (block B22). The error detection code comparing section 172 obtains the exclusive OR (XOR) of the readout redundant data and the generated CRC (block B23), and the data check section 173 confirms whether or not the data check bit sequences are all zero (block B24). If the data check bit sequences are all zero (block B24: Yes), the key information check section 174 checks the key generation information with the protection code (block B25), and if the error is not detected (block B26: No), the key examining section 175 compares the key generation information (key generation information contained in the redundant data) read out from the media 30 and the current key generation information (block B27). If the key generation information match (block B28: Yes), the key examining section 175 stores the actual data read out from the media 30 in the SDRAM 20 (block B29). If the key generation information do not match (block B28: No), a data pattern indicating that the data is not effective is stored in the SDRAM 20 in place of the actual data (block B31). In this case, the decryption is by-passed in the encryption processor 15, a certain fixed pattern is output with respect to the host device 2, and the host device 2 is able to detect that the received data is the data that cannot be decrypted. If the data check bit sequences are not all zero (block B24: No), or if the error of the key generation information is detected (block B26: Yes), the readout processor 17 determines as the CRC error (block B30), and terminates the readout operation of the data. In this case, the readout processor 17 notifies the detection of the CRC error to the command control unit 13.

In the flowchart of FIG. 7, the error check of the actual data (block B24) is carried out first, and then the error check of the key generation information and the examination of the key generation (blocks 325 to S28) are carried out, but the order may be interchanged.

The data protection strength by the storage device of the present embodiment will be supplementary explained. For example, if the error detection code is the CRC, the CRC is 48 bits, the key information is 20 bits, and the protection code is 2 bits, the 26 bits of the CRC portion (portion of <2> of FIG. 6), where the key information and the protection code are not attached, and the 2 bits of the protection code become the protection strength of the data and respectively become ½²⁶ and ½², and hence the protection strength of ½²⁸ can be anticipated for the entire storage device. In this case, if the key information is the key generation information, for example, if the generation of the encryption key is expressed with 8 bits, the difference of 12 bits from the 20 bits assigned for the key information can be used for the bits of the CRC, whereby the strength of the CRC can be enhanced to 28+12=40 bits, that is, 1/2⁴⁰.

Therefore, according to the present embodiment, when storing the data received from the host device 2, the storage device 1 first encrypts the data, the storage device 1 then generates the error detection code for checking the error of the data after the encryption, the key information, which is the information of the encryption key used in encrypting the data, and the protection code for checking the error of the key information. Furthermore, the redundant data, which is the error detection code attached with the key information and the protection code, is generated by calculating the exclusive OR of the error detection code, and the key information and the protection code. The redundant data is added to the data of after the encryption, and then stored. When outputting the stored data to the host device 2, the redundant data added to the data is used to perform the error check of the data, and the right and wrong determination of the encryption key used in the decryption (determination on whether or not the encryption key used in the encryption and the encryption key used in the decryption match). Furthermore, when carrying out the match and unmatch determination of the encryption key, the error check of the key information to use in the determination process is carried out. The malfunction caused by the error of the key information is thereby suppressed, and the reliability of the device can be enhanced. Moreover, the lowering of the data protection strength due to the attachment of the key information and the protection code to the error detection code can be suppressed to a minimum since the bit size of the key information can be varied.

In the embodiment described above, a case in which the storage device is the hard disk drive has been described by way of example, but the storage device may be a SSD (Solid State Drive).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a buffer configured to store encrypted data;
an error detection code generator configured to generate an error detection code of the encrypted data stored in the buffer;
a key information generator configured to generate key information which is information of an encryption key used in the encryption of the encrypted data;
a protection code generator configured to generate a protection code which is an error detection code of the key information;
a key information attaching unit configured to attach the key information and the protection code to the error detection code, and add to the encrypted data as redundant data; and
a media configured to store the encrypted data added with the redundant data.

2. The storage device according to claim 1, wherein the key information attaching unit generates redundant data of the same number of bits as the error detection code.

3. The storage device according to claim 1, wherein the redundant data is an exclusive OR of the key information, the protection code, and the error detection code.

4. The storage device according to claim 1, further comprising:
an error detection code generator configured to read out the encrypted data added with the redundant data from the media, and generate an error detection code of the readout encrypted data;
a comparing section configured to compare the generated error detection code with the readout redundant data;
a data check section configured to execute an error check of the readout encrypted data based on the comparison result;
a key information check section configured to execute an error check of the key information contained in the readout redundant data based on the comparison result; and
a key examining section configured to determine whether or not an encryption key used in the encryption of the readout encrypted data is most recent encryption key based on the key information contained in the readout redundant data.

5. The storage device according to claim 4, wherein the key examining section stores the readout encrypted data in the buffer when the encryption key used in the encryption of the readout encrypted data is the most recent encryption key, and stores a bit pattern indicating invalid data in the buffer when the encryption key used in the encryption of the readout encrypted data is not the most recent encryption key.

6. The storage device according to claim 4, wherein the key information check section is configured to execute an error check of the key information contained in the readout redundant data when an error is not detected in the error check by the data check section.

7. The storage device according to claim 4, wherein the key examining section determines whether or not the encryption key used in the encryption of the readout encrypted data is the most recent encryption key when an error is not detected in the error check by the key information check section.

8. The storage device according to claim 3, further comprising:
an error detection code generator configured to read out the encrypted data added with the redundant data from the media, and generate an error detection code of the readout encrypted data;
a comparing section configured to compare the generated error detection code with the readout redundant data;
a data check section configured to execute an error check of the readout encrypted data based on the comparison result;
a key information check section configured to execute an error check of the key information contained in the readout redundant data based on the comparison result; and
a key examining section configured to determine whether or not an encryption key used in the encryption of the readout encrypted data is most recent encryption key based on the key information contained in the readout redundant data.

9. The storage device according to claim 8, wherein the comparing section extracts the key information and the protection code from the redundant data by calculating an exclusive OR of the error detection code and the redundant data.

10. The storage device according to claim 8, wherein the key examining section stores the readout encrypted data in the buffer when the encryption key used in the encryption of the readout encrypted data is the most recent encryption key, and stores a bit pattern indicating invalid data in the buffer when the encryption key used in the encryption of the readout encrypted data is not the most recent encryption key.

11. A controller configured to process encrypted data encrypted using an encryption key, the controller comprising:
an error detection code generator configured to generate an error detection code of the encrypted data;
a key information generator configured to generate key information which is information of an encryption key used in the encryption of the encrypted data;
a protection code generator configured to generate a protection code which is an error detection code of the key information; and
a key information attaching unit configured to attach the key information and the protection code to the error detection code, and add to the encrypted data as redundant data.

12. The controller according to claim 11, wherein the key information attaching unit generates redundant data of the same number of bits as the error detection code.

13. The controller according to claim 11, wherein the redundant data is an exclusive OR of the key information, the protection code, and the error detection code.

14. The controller according to claim 11, further comprising:
an error detection code generator configured to input encrypted data added with the redundant data, and generate an error detection code of the input encrypted data;
a comparing section configured to compare the generated error detection code with the readout redundant data;
a data check section configured to execute an error check of the readout encrypted data based on the comparison result;
a key information check section configured to execute an error check of the key information contained in the readout redundant data based on the comparison result; and
a key examining section configured to determine whether or not the encryption key used in the encryption of the readout encrypted data is the most recent encryption key based on the key information contained in the readout redundant data.

15. The controller according to claim 14, wherein the key examining section outputs the readout encrypted data when the encryption key used in the encryption of the readout encrypted data is the most recent encryption key, and outputs a bit pattern indicating invalid data when the encryption key used in the encryption of the readout encrypted data is not the most recent encryption key.

16. The controller according to claim 13, further comprising:
an error detection code generator configured to input encrypted data added with the redundant data, and generate an error detection code of the input encrypted data;
a comparing section configured to compare the generated error detection code with the readout redundant data;
a data check section configured to execute an error check of the readout encrypted data based on the comparison result;
a key information check section configured to execute an error check of the key information contained in the readout redundant data based on the comparison result; and
a key examining section configured to determine whether or not the encryption key used in the encryption of the readout encrypted data is the most recent encryption key based on the key information contained in the readout redundant data.

17. The controller according to claim 16, wherein the comparing section extracts the key information and the protection code from the redundant data by calculating an exclusive OR of the error detection code and the redundant data.

18. The controller according to claim 16, wherein the key examining section outputs the readout encrypted data when the encryption key used in the encryption of the readout encrypted data is the most recent encryption key, and outputs a bit pattern indicating invalid data when the encryption key used in the encryption of the readout encrypted data is not the most recent encryption key.

19. A data writing method in a controller for processing encrypted data encrypted using an encryption key, the method comprising:
generating an error detection code of the encrypted data;
generating key information which is information of an encryption key used in the encryption of the encrypted data;
generating a protection code which is an error detection code of the key information; and
attaching the key information and the protection code to the error detection code, adding to the encrypted data as redundant data.

20. The data writing method according to claim 19, wherein the redundant data is an exclusive OR of the key information, the protection code, and the error detection code.
